(19) United States
(12) Patent Application Publication
(10) Pub. No.: US 2018/0024928 A1
(43) Pub. Date: Jan. 25, 2018

(54) MODIFIED QUERY EXECUTION PLANS IN HYBRID MEMORY SYSTEMS FOR IN-MEMORY DATABASES

(71) Applicant: SAP SE, Walldorf (DE)

(72) Inventor: Ahmad Hassan, Belfast (IE)

(21) Appl. No.: 15/213,816

(22) Filed: Jul. 19, 2016

(51) Int. Cl. G06F 12/0844

(52) U.S. Cl. CPC G06F 12/0844; G06F 2212/1021; G06F 2212/151; G06F 2212/281

(57) ABSTRACT

Implementations of the present disclosure include methods, systems, and computer-readable storage mediums for receiving a query from an application, processing a query execution plan (QEP) of the query using a cache simulator to simulate queries to an in-memory database in a hybrid memory system, providing a miss-curve based on the QEP, the miss-curve relating miss-ratios to memory sizes, and determining relative sizes of a first type of memory and a second type of memory in the hybrid memory system at least partially based on the miss-curve.

### BACKGROUND

A business or other type of enterprise may operate enterprise systems to provide software functionality to customers and employees. An enterprise system may include back-end enterprise servers that host enterprise applications such as enterprise resource planning (ERP) systems, client-relationship management (CRM) systems, product lifecycle management (PLM) systems, supply chain management (SCM) systems, supplier relationship management (SRM) systems, and so forth. During the execution of an enterprise application, application data may be placed in or accessed from the main memory of the enterprise server, such that the application data is immediately accessible by processors of the enterprise server.

Increasingly, large amounts of application data are stored in the main memory of enterprise servers. Main memory may include dynamic random access memory (DRAM), which consumes a relatively high amount of static energy both in active and idle states due to continuous leakage and refresh power. Various byte-addressable non-volatile memory (NVM) technologies promise near-zero static energy and persistence. However, NVM may exhibit high latency and high dynamic energy relative to DRAM.

### SUMMARY

Implementations of the present disclosure include computer-implemented methods for using modified query execution plans in in-memory database systems. In some implementations, methods include actions of receiving a query from an application, processing a query execution plan (QEP) of the query using a cache simulator to simulate queries to an in-memory database in a hybrid memory system, providing a miss-curve based on the QEP, the miss-curve relating miss-ratios to memory sizes, and determining relative sizes of a first type of memory and a second type of memory in the hybrid memory system at least partially based on the miss-curve.

These and other implementations may each optionally include one or more of the following features: determining relative sizes of the first type of memory and the second type of memory includes: providing a threshold miss-ratio, determining, using the miss-curve, a memory size corresponding to the threshold miss-ratio, and providing a size of one of the first type of memory and the second type of memory as the memory size; the miss-curve is provided based on fragmenting one or more relations to respectively provide one or more fragmented relations, the QEP being executed over the one or more fragmented relations using the cache simulator; after the first type of memory and the second type of memory are sized in the hybrid memory system, QEPs to be executed on the hybrid memory system are executed over fragmented relations; the miss-curve is one of a plurality of miss-curves, and the relative sizes of the first type of memory and the second type of memory are determined at least partially based on the plurality of miss-curves; the first type of memory includes dynamic random access memory (DRAM), and the second type of memory includes non-volatile memory (NVM); and actions further include: receiving source code of the application, providing an instrumented application that includes the source code and instrumentation code, the instrumented application including at least one instruction for profiling memory traffic of the application, and executing the instrumented application to process the QEP to provide the miss-curve.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example memory architecture in accordance with implementations such as those of the present disclosure.

FIG. 2 depicts an example architecture to provide main memory miss-curves for a range of configured memory sizes in accordance with implementations of the present disclosure.

FIGS. 3A and 3B depict example miss-curves in accordance with implementations of the present disclosure.

FIG. 4 depicts an example process that can be executed in accordance with implementations such as those of the present disclosure.

FIG. 5 is a schematic illustration of example computer systems that may be employed for implementations such as those of the present disclosure.

Like reference symbols in the various drawings indicate like elements.

### DETAILED DESCRIPTION

Implementations of the present disclosure are generally directed to using modified query execution plans in in-memory database systems. More particularly, implementations of the present disclosure are directed to executing query execution plans (QEPs) over fragmented relations (tables) to query an in-memory database. In some examples, and as described in further detail herein, executing QEPs over fragmented relations can reduce the amount of dynamic random access memory (DRAM) used within a hybrid memory system, thereby reducing the energy of in-memory database systems.

To provide context for implementations of the present disclosure, real-time data analytics aim at making knowledge available with sub-second and often sub-millisecond response time. For example, real-time enterprise resource planning (ERP) systems enable enterprises to view every change in the enterprise as soon as it happens, and can be a driver in the success of the enterprise. In some examples, real-time access to information helps in gaining competitive advantage through efficient and improved (e.g., more informed) decision making, product pricing, risk management, product life-cycle, customer feedback, customer engagement, brand development, product pricing, and reduced total cost of ownership (TCO). The growing volumes of enterprise data makes it challenging to achieve the target response times in real-time data analytics.

The advances in multi-core processing, caching and less expensive main memory has brought a major breakthrough in designing real-time enterprise systems. In-memory databases open doors for real-time analytics as it uses faster main-memory as a primary storage and bypass I/O disk delays in analytical data processing. Improvements in both hardware and in-memory databases have triggered the unification of both operational and analytical storage models together in a unified in-memory data store. For example, slower, disk-based memory is only required for persistent storage. This has a negligible impact on the throughput of in-memory databases, because persistence is moved from the critical path. Accordingly, in-memory databases enable real-time data analytics on unified data with minimal response times, because the data resides in main memory, which is an order of magnitude faster for accessing than traditional, disk-based memory.

In-memory databases can be implemented in hybrid memory systems, which can include non-volatile memory (NVM) and dynamic random access memory (DRAM). In general, NVM provides persistence (like a traditional hard disk), and byte-addressability (like conventional DRAM). NVM is also referred as storage class memory (SCM). Examples NVM include phase change memory (PCM), spin transfer torque memory (STT-RAM), and memristors. DRAM uses capacitance to store electric charge, which requires continuous power due to leakage. NVM uses resistance, rather than capacitance, for bit representation. Both DRAM and NVM consume static energy and dynamic energy. Static energy is consumed at all times when the memory system is switched on, and is independent of any memory accesses. Dynamic energy is an energy that is consumed by an actual read or a write operation (memory accesses). Static energy is further divided into cell leakage energy, and refresh energy. NVM is superior to DRAM with respect to static energy consumption, because NVM has low leakage energy, and does not require refresh energy. With non-negligible leakage power and relatively high refresh power, DRAM can consume 30-40% of the total server power. The DRAM size directly influences the power consumption of the servers.

NVM is more scalable than DRAM. For example, it has been shown that PCM can scale down to 10 nm, while the ability of DRAM to scale below 22 nm feature sizes is yet to be confirmed. Through NVM, such highly scalable and denser main memory storage enables building of enterprise systems with larger main memory storage capacity. However, the read or write access latency and dynamic energy of NVM are higher than DRAM. For example, the read latency and the write latency of PCM is approximately 4.4× and 12× times that of DRAM, respectively. As another example, the read dynamic energy and the write dynamic energy of PCM is approximately 2× and 43× times that of DRAM, respectively. Further, the storage cells of NVM wear with the usage.

Accordingly, the discrepancies in access latency and dynamic energy, as well as wear of NVM, pose challenges in using NVM as an alternative to DRAM. However, the scaling properties and low static energy of NVM are motivating factors in the design of energy efficient hybrid main memory systems that include both NVM and DRAM. In general, designing an energy efficient hybrid memory system typically focuses on designing a hybrid memory system that is more energy efficient than a DRAM-only memory system. Here, energy efficiency is achieved through the low static energy of NVM in comparison to DRAM. One strategy is to replace as much DRAM as possible with SCM for reducing the energy consumption of the system, with a constraint of keeping the performance degradation (which results from NVM) to a defined minimum. In order to benefit from NVM in a hybrid memory system, an application-specific, hybrid memory system should be designed with appropriate sizes of NVM and DRAM.

Implementations are applicable to hybrid main memory systems, including DRAM and NVM, to support the operations of one or more applications executing in an enterprise environments, or any other appropriate computing environment. For example, application(s) may employ an in-memory database to enable access to the database with lower latency than may be exhibited when accessing a database stored in a disk storage device. Implementations of the present disclosure may analyze one or more data processing functions, which may be included in a QEP of an application. A data processing function, which may also be referred to as a function or an operator, may include any number of data access operations such as read operations and write operations.

In view of the above context, and as described in further detail herein, implementations of the present disclosure are generally directed to executing QEPs over fragment relations (tables) in in-memory database systems. More particularly, implementations of the present disclosure are directed to executing QEPs over fragmented relations to query an in-memory database in a hybrid memory system. In some examples, and as described in further detail herein, executing QEPs over fragmented relations can reduce the amount of DRAM used within a hybrid memory system, thereby reducing the energy of in-memory database system, and/or can reduce the execution time of queries.

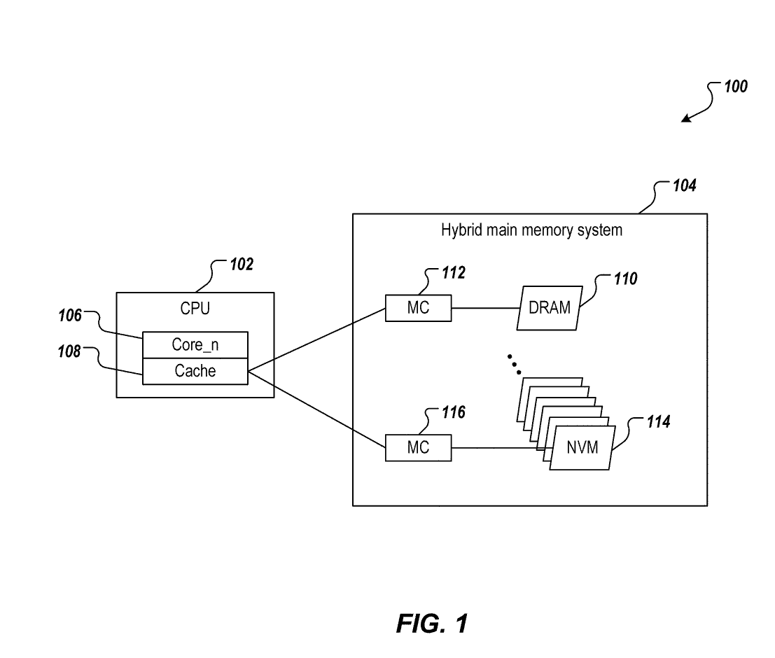

FIG. 1 depicts an example memory architecture 100 that may be implemented within an enterprise server or other type of computing device(s). In the example of FIG. 1, the example memory architecture 100 includes a central processing unit (CPU) 102 and a hybrid main memory system 104. The CPU 102 includes a core 106 having a respective cache 108. Although a single core 106 and respective cache 108 is depicted, it is appreciated that the CPU 102 may include multiple cores 106, each with a respective cache 108. Further, although a single CPU 102 is depicted, it is appreciated that computing device(s) may include multiple CPUs 102. The main memory system 104 includes DRAM 110 with a respective memory controller (MC) 112, and NVM 114 with a respective MC 116. In some cases, a cache 108 accesses (e.g., reads, writes, deletes, etc.) data in the DRAM 110 through the MC 112, and accesses data in the NVM 114 through the MC 116. The hybrid main memory system 104 may include any number of instances, or cells, of DRAM and NVM, to provide any amount of memory for use by the CPU(s) 102.

In some examples, the example memory architecture 100 may support an in-memory database that uses main memory for data storage. Main memory may include one or more types of memory (e.g., DRAM, NVM) that communicates with one or more processors, e.g., CPU(s), over a memory bus. An in-memory database system may be contrasted with database management systems that employ a disk storage mechanism. In some examples, in-memory database systems may be faster than disk storage databases, because internal optimization algorithms may be simpler and execute fewer CPU instructions. In some examples, accessing data in an in-memory database system may reduce or eliminate seek time when querying the data, providing faster and more predictable performance than disk-storage databases. An in-memory database may include a row-oriented database, in which data is stored in any number of rows or records. An in-memory database may also include a column-oriented in-memory database, in which data tables are stored as sections of columns of data (rather than as rows of data). An example in-memory database system is HANA™, provided by SAP™ SE of Walldorf, Germany.

As described in further detail herein, implementations of the present disclosure provide for memory sizing of DRAM and NVM for in-memory databases in hybrid memory systems, contribute to minimizing the size of DRAM for in-memory databases through fragmented relations, and provide a tool chain for capacity planning, optimization, and analysis of fragmented QEPs. In accordance with implementations of the present disclosure, DRAM size can be reduced and replaced by NVM memory with minimal and acceptable performance penalty. More specifically, the hybrid memory system can be designed to include optimal sizes of each memory as per workload requirements, and intelligent data management techniques are implemented.

Implementations of the present disclosure have been evaluated using a set of benchmark queries executed on an in-memory database in a hybrid memory system. The set of benchmark used include queries provided in the TPC Benchmark H (TPC-H) provided by the Transaction Processing Performance Council of San Francisco, Calif. The TPC-H is a decision support benchmark that includes a set of business oriented ad-hoc queries (e.g., a set of benchmark queries), and concurrent data modifications. The TPC-H is described as being representative of decision support systems that examine large volumes of data, execute queries with a high degree of complexity, and provide answers to critical business questions.

In accordance with the present disclosure, in order to design a hybrid memory system that is more energy efficient (as compared to DRAM-only memory system), the architecture of the memory hierarchy and the respective sizes of each type of main memory (e.g., DRAM, NVM) are determined. The present disclosure provides a tool to determine appropriate sizes of DRAM and NVM for a given workload. In some implementations, and as described in further detail herein, mitosis is applied to provide fragmented relations. In some examples, the fragmented relations improve the cache locality when executing a QEP, and reduce the size of DRAM needed in the hybrid memory system. In this manner, energy efficiency of the hybrid memory system is improved.

In accordance with the present disclosure, a tool is implemented for simulating multiple main memory configurations at the same time. In some examples, a cache simulator can be used. An example cache simulator includes the Cheetah Simulator, which is an open source cache simulation package, which can simulate various cache configurations in a single pass using address traces. In some implementations, an in-memory database is instrumented, and the instrumented code is executed to collect data that is used to provide main memory miss-curves. In some examples, a miss-curve graphically depicts a miss rate, which represents the amount of traffic (e.g., read/write access to main memory) that does not hit the main memory during queries to the in-memory database system. In some implementations, the tool is configured with a lower bound (e.g., 1 KB) and an upper bound (e.g, 2 GB) of the main memory that is to be simulated.

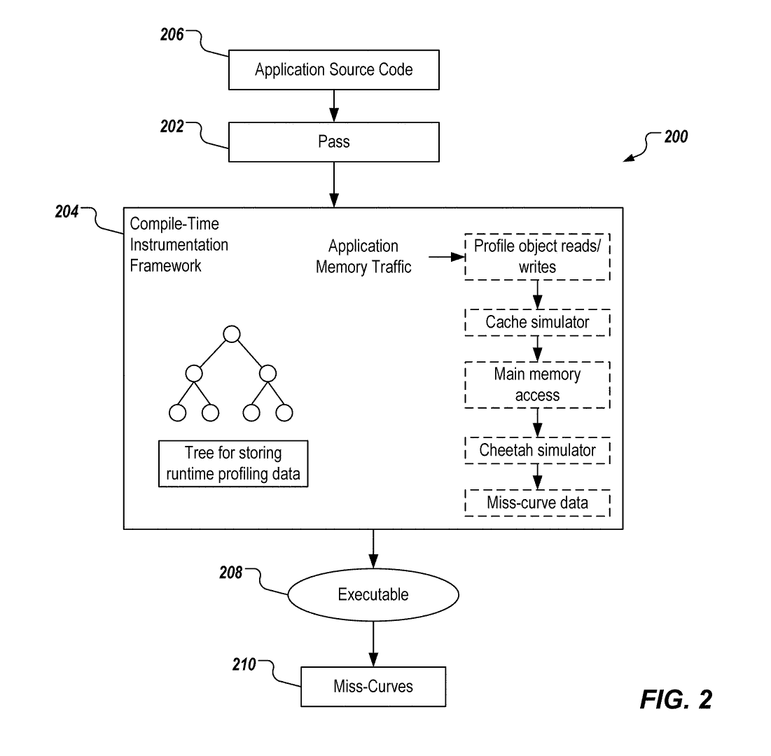

FIG. 2 depicts an example architecture 200 to provide main memory miss-curves for a range of configured memory sizes in accordance with implementations of the present disclosure. In the depicted example, the example architecture 200 includes a pass 202 (e.g., an LLVM pass), and a compile-time instrumentation framework 204. In some examples, the pass 202 receives application source code 206 (e.g., source code of the application that is to be profiled), and provides executable code 208. In some examples, the pass 202 compiles the source code and adds instrumentation code to provide the executable code 208. In some examples, the instrumentation code includes instructions to profile the application during execution (e.g., objects, sizes, loads/stores of allocations).

In some examples, the executable code 208 is provided as bit-code (e.g., machine-readable code) and is executed by the compile-time instrumentation framework 204 to provide a miss-curves file 210, as described in further detail herein. In some examples, the miss-curves file 210 provides miss data that can be used to construct one or more miss-curves, discussed in further detail herein.

In further detail, the instrumented executable code 208 can be executed to perform a set of benchmark queries (e.g., TPC-H, described above). During execution of the instrumented executable code 208, all loads and stores performed by the application (e.g., object reads/writes) are collected, and are passed to a cache simulator to identify accesses that go through main memory (e.g., main memory traffic). The main memory traffic is processed by the Cheetah Simulator, which is configured with main memory ranging between a lower bound and an upper bound (e.g., 1 KB to 2 GB). The Cheetah Simulator provides the miss-curve data for the configured range of memory (e.g., 1 KB to 2 GB). In some examples, a miss-curve provides data to determine the miss rate in a main memory system configured with X bytes of memory. In some examples, the miss rate indicates the amount of traffic that does not hit the main memory of X bytes.

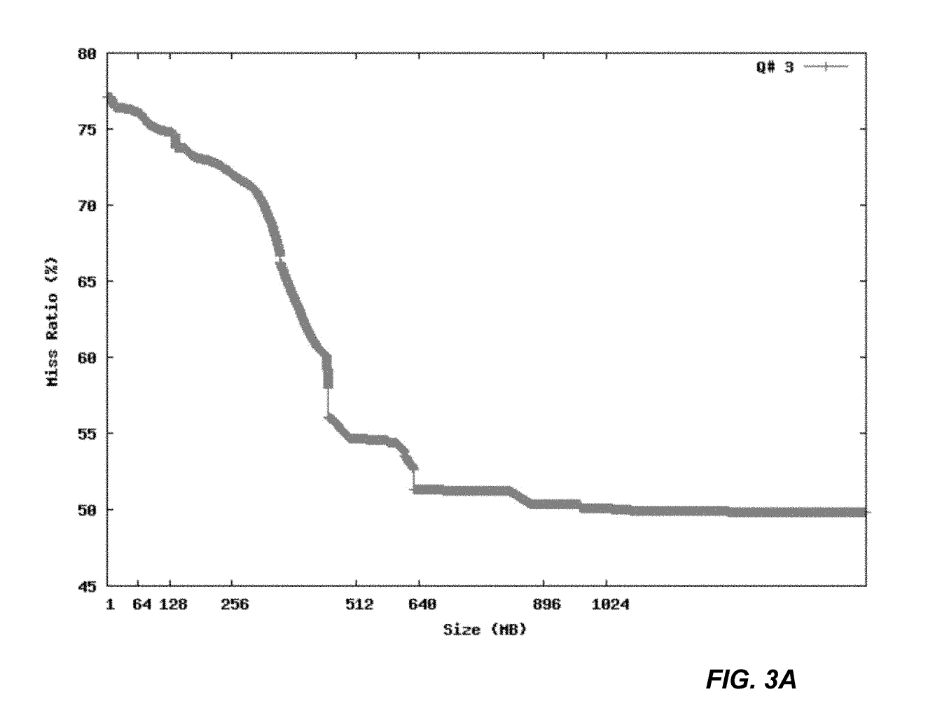

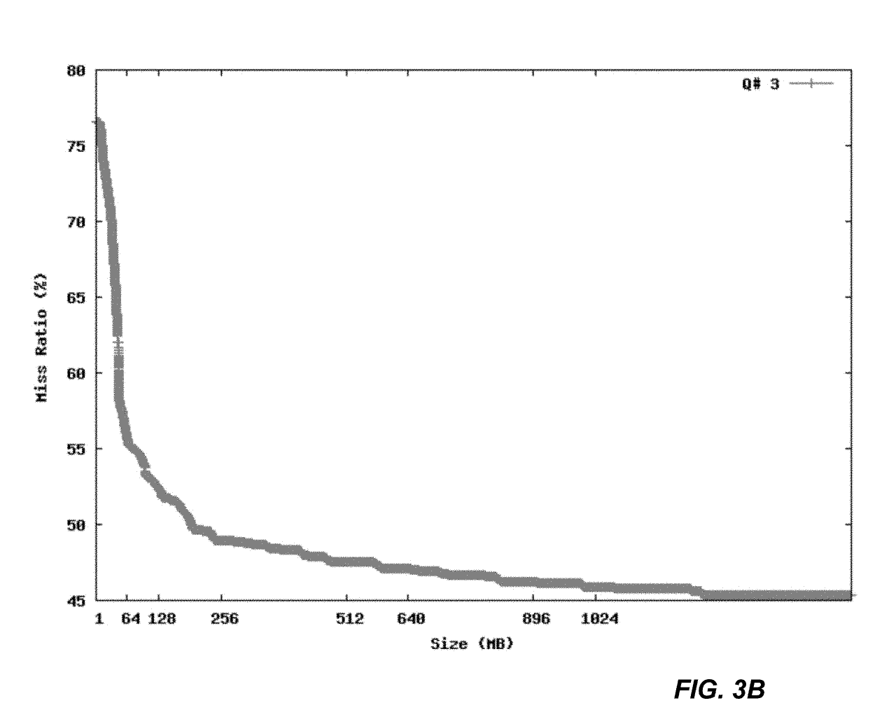

FIGS. 3A and 3B depict example miss-curves in accordance with implementations of the present disclosure. The examples of FIGS. 3A and 3B are based on processing of Query #3 in TPC-H. Query #3 (Q#3) is a Shipping Priority query, which retrieves the shipping priority and potential revenue of the orders having the largest revenue among those that had not been shipped as of a given date, and provides a result including 10 unshipped orders with highest value, which are listed in decreasing order of revenue.

In the examples of FIGS. 3A and 3B, simulated memory sizes ranging from 1 KB to 2 GB are provided on the horizontal axis (x-axis), and memory miss percentages (miss-ratios) are provided on the vertical axis (y-axis). In some examples, the miss percentage indicates the percentage of memory that is not served. The point on the horizontal axis of miss curves, after which there is no decrease, or a significantly slowed decrease in the miss ratio, indicates the size for the faster access memory. In a hybrid memory system, DRAM is the faster access memory (relative to NVM), but less energy efficient (relative to NVM). With particular reference to FIG. 3A, the size of the DRAM can be selected as 1024 MB, which, no matter what the size of main memory is, the miss ratio remains constant at approximately 50%. This value can be used as the delineation point between DRAM sizing and NVM sizing in a hybrid memory system.

In an ideal scenario, the size of DRAM is minimized, while maintaining the same miss ratio. As noted above, a reduction in DRAM provides increased energy efficiency (e.g., less energy consumption than with more DRAM), and less memory cost. To further reduce the size of DRAM, implementations of the presentation include mitosis to provide fragmented relations, over which a QEP is executed. In some examples, one or more relations are fragmented into multiple components, and the QEP is adjusted to execute over the multiple components, thereby exploiting the caches of multiple processing cores. In some examples, the smaller relation fragments (components) for data processing are ideal to fit into the caches of enterprise systems, and exploit the locality with in caches. In this manner, most of the data is processed in the caches, and the amount of traffic going to main memory is reduced. In mitosis, a relation (table) is broken down into M fragments. This approach better uses multi-core parallelism, and improves the application cache locality. The goal of mitosis is to apply horizontal partitioning, and run analysis on smaller subsets of data. In some examples, the granularity of partitioning is important, because too many fragments can cause contention in the caches, where multiple threads will be scheduled to single core and the data will be fetched into the caches for each of the fragments. The tool of the present disclosure, described above, enables selection of the number of fragments M, and provides respective miss-curves for each configuration. In this manner, the best suitable value for M for a given workload (e.g., TPC-H) can be determined. In experiments performed using implementations of the present disclosure, an example of M=10 was selected, and each function call of an original QEP was broken into 10 smaller fragments. The results of the fragments were combined to provide the response to the query Q, underlying the original QEP. The experiments conducted on implementations of the present disclosure confirmed that the size of DRAM can be reduced using fragmented QEPs, as compared to non-fragmented QEPs.

FIG. 3B depicts an example miss-curve for TPC-H Q #3, where a partition of 10 fragments (i.e., M=10) is used. In the depicted example, and as compared to FIG. 3A, the miss-curve of FIG. 3B indicates that the size of DRAM can be reduced to 150 MB, while still achieving a miss rate of up to 50%. As discussed above with reference to FIG. 3B, non-fragmented execution for the same TPC-H query requires a DRAM of 1024 MB to achieve the same miss rate up to 50%. Experiments conducted on implementations of the present disclosure revealed a similar trend across all other TPC-H queries as benchmark workloads.

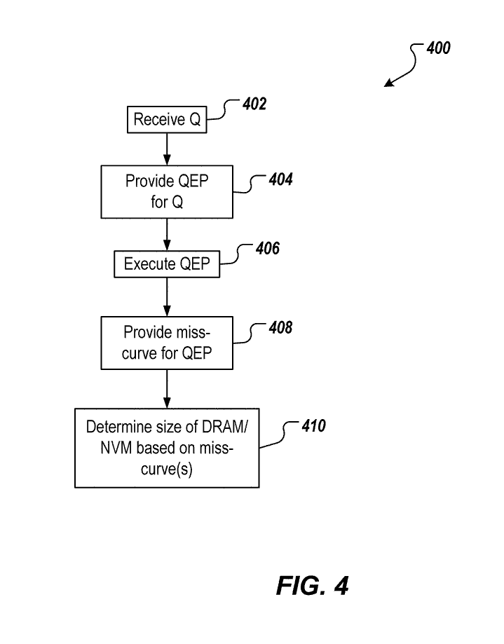

FIG. 4 depicts an example process 400 that can be executed in accordance with implementations of the present disclosure. In some implementations, the example process 400 may be performed using one or more computer-executable programs executed using one or more computing devices.

A query Q is received (402). For example, a query (e.g., SQL query) can be submitted using an application. In some examples, the application interacts with an in-memory database to provide a result to the query. A QEP is provided for the Q (404). In some examples, the QEP is pre-stored in memory, and is retrieved from memory based on the Q. In some examples, the QEP includes a plurality of operators provided in respective lines L. For example, the QEP can include lines L₁, . . . , Lₘ, each line being associated with a respective operator. In some examples, the operators of all lines L₁, . . . , Lₘ are performed to provide the query results. In some examples, the operators of lines L₁, . . . , Lₘ, (where x is an integer that is greater than zero and less than m−1) to provide an intermediate result. In some examples, a result of an operator (producer) of a line L₁, Lₘ₋₁, is an intermediate result that is provided to an operator (consumer) of a subsequent line (e.g., L₂, . . . , Lₘ), and the result of the operator of the last line Lₘ is provided as the query result.

The QEP is executed (408). For example, operators of the QEP are executed in line order (e.g., beginning with L₁) to incrementally provide respective intermediate results. In some examples, the QEP is executed using a cache simulator, as described above with reference to FIG. 2, and a miss-curve is provided (408). In some examples, a plurality of QEPs can be executed to provide a plurality of miss-curves, each miss-curve corresponding to a respective QEP. In some examples, one or more relations implicated by the query are fragmented, and the QEP is modified and executed to provide the respective miss-curve. Respective sizes of DRAM and NVM are determined for the hybrid memory system based on at least one miss-curve (410), as described herein.

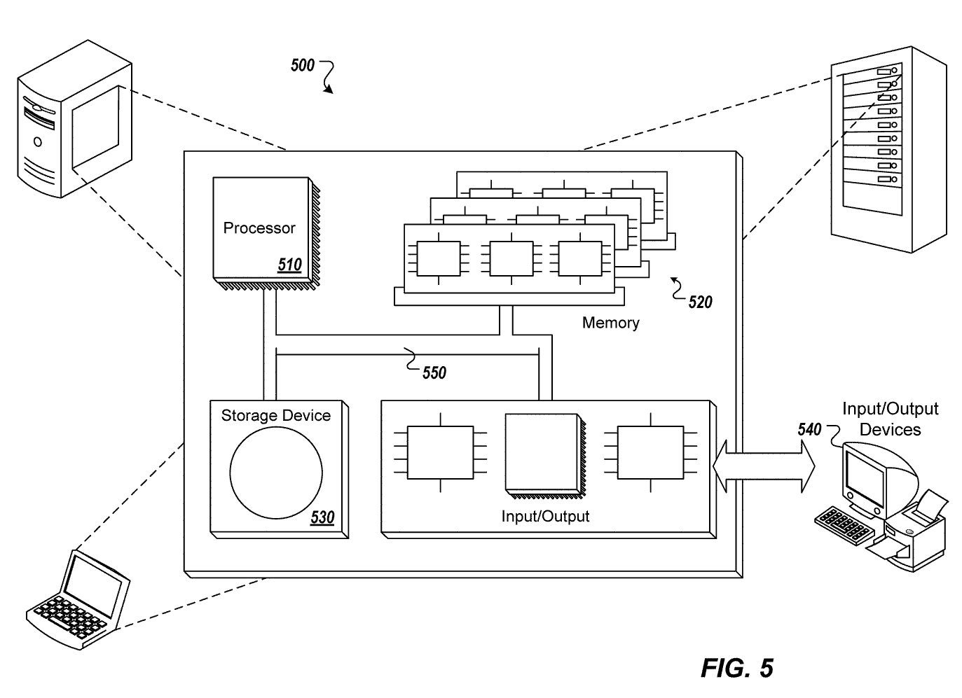

FIG. 5 depicts a schematic diagram of an example computing system 500. The system 500 may be used to perform the operations described with regard to one or more implementations of the present disclosure. For example, the system 500 may be included in any or all of the server components, or other computing device(s), discussed herein. The system 500 may include one or more processors 510, one or more memories 520, one or more storage devices 530, and one or more input/output (I/O) devices 540. The components 510, 520, 530, 540 may be interconnected using a system bus 550.

The processor 510 may be configured to execute instructions within the system 500. The processor 510 may include a single-threaded processor or a multi-threaded processor. The processor 510 may be configured to execute or otherwise process instructions stored in one or both of the memory 520 or the storage device 530. Execution of the instruction(s) may cause graphical information to be displayed or otherwise presented via a user interface on the I/O device 540. The processor(s) 510 may include the CPU 102.

The memory 520 may store information within the system 500. In some implementations, the memory 520 is a computer-readable medium. In some implementations, the memory 520 may include one or more volatile memory units. In some implementations, the memory 520 may include one or more non-volatile memory units. The memory 520 may include the hybrid main memory system 104.

The storage device 530 may be configured to provide mass storage for the system 500. In some implementations, the storage device 530 is a computer-readable medium. The storage device 530 may include a floppy disk device, a hard disk device, an optical disk device, a tape device, or other type of storage device. The I/O device 540 may provide I/O operations for the system 500. In some implementations, the I/O device 540 may include a keyboard, a pointing device, or other devices for data input. In some implementations, the I/O device 540 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors, the method comprising:
receiving, by the one or more processors, a query from an application;
processing, by the one or more processors, a query execution plan (QEP) of the query using a cache simulator to simulate queries to an in-memory database in a hybrid memory system;
providing, by the one or more processors, a miss-curve based on the QEP, the miss-curve relating miss-ratios to memory sizes; and
determining relative sizes of a first type of memory and a second type of memory in the hybrid memory system at least partially based on the miss-curve.

2. The method of claim 1, wherein determining relative sizes of the first type of memory and the second type of memory comprises:
providing a threshold miss-ratio;
determining, using the miss-curve, a memory size corresponding to the threshold miss-ratio; and
providing a size of one of the first type of memory and the second type of memory as the memory size.

3. The method of claim 1, wherein the miss-curve is provided based on fragmenting one or more relations to respectively provide one or more fragmented relations, the QEP being executed over the one or more fragmented relations using the cache simulator.

4. The method of claim 3, wherein, after the first type of memory and the second type of memory are sized in the hybrid memory system, QEPs to be executed on the hybrid memory system are executed over fragmented relations.

5. The method of claim 1, wherein the miss-curve is one of a plurality of miss-curves, and the relative sizes of the first type of memory and the second type of memory are determined at least partially based on the plurality of miss-curves.

6. The method of claim 1, wherein the first type of memory comprises dynamic random access memory (DRAM), and the second type of memory comprises non-volatile memory (NVM).

7. The method of claim 1, further comprising:
receiving source code of the application;
providing an instrumented application that includes the source code and instrumentation code, the instrumented application comprising at least one instruction for profiling memory traffic of the application; and
executing the instrumented application to process the QEP to provide the miss-curve.

8. A non-transitory computer-readable storage medium coupled to one or more processors and having instructions stored thereon which, when executed by the one or more processors, cause the one or more processors to perform operations comprising:
receiving a query from an application;
processing a query execution plan (QEP) of the query using a cache simulator to simulate queries to an in-memory database in a hybrid memory system;
providing a miss-curve based on the QEP, the miss-curve relating miss-ratios to memory sizes; and
determining relative sizes of a first type of memory and a second type of memory in the hybrid memory system at least partially based on the miss-curve.

9. The computer-readable storage medium of claim 8, wherein determining relative sizes of the first type of memory and the second type of memory comprises:
providing a threshold miss-ratio;
determining, using the miss-curve, a memory size corresponding to the threshold miss-ratio; and
providing a size of one of the first type of memory and the second type of memory as the memory size.

10. The computer-readable storage medium of claim 8, wherein the miss-curve is provided based on fragmenting one or more relations to respectively provide one or more fragmented relations, the QEP being executed over the one or more fragmented relations using the cache simulator.

11. The computer-readable storage medium of claim 10, wherein, after the first type of memory and the second type of memory are sized in the hybrid memory system, QEPs to be executed on the hybrid memory system are executed over fragmented relations.

12. The computer-readable storage medium of claim 8, wherein the miss-curve is one of a plurality of miss-curves, and the relative sizes of the first type of memory and the second type of memory are determined at least partially based on the plurality of miss-curves.

13. The computer-readable storage medium of claim 8, wherein the first type of memory comprises dynamic random access memory (DRAM), and the second type of memory comprises non-volatile memory (NVM).

14. The computer-readable storage medium of claim 8, wherein operations further comprise:
receiving source code of the application;
providing an instrumented application that includes the source code and instrumentation code, the instrumented application comprising at least one instruction for profiling memory traffic of the application; and
executing the instrumented application to process the QEP to provide the miss-curve.

15. A system, comprising:
a computing device; and
a computer-readable storage device coupled to the computing device and having instructions stored thereon which, when executed by the computing device, cause the computing device to perform operations comprising:
receiving a query from an application;
processing a query execution plan (QEP) of the query using a cache simulator to simulate queries to an in-memory database in a hybrid memory system;
providing a miss-curve based on the QEP, the miss-curve relating miss-ratios to memory sizes; and
determining relative sizes of a first type of memory and a second type of memory in the hybrid memory system at least partially based on the miss-curve.

16. The system of claim 15, wherein determining relative sizes of the first type of memory and the second type of memory comprises:
providing a threshold miss-ratio;
determining, using the miss-curve, a memory size corresponding to the threshold miss-ratio; and
providing a size of one of the first type of memory and the second type of memory as the memory size.

17. The system of claim 15, wherein the miss-curve is provided based on fragmenting one or more relations to respectively provide one or more fragmented relations, the QEP being executed over the one or more fragmented relations using the cache simulator.

18. The system of claim 17, wherein, after the first type of memory and the second type of memory are sized in the hybrid memory system, QEPs to be executed on the hybrid memory system are executed over fragmented relations.

19. The system of claim 15, wherein the miss-curve is one of a plurality of miss-curves, and the relative sizes of the first type of memory and the second type of memory are determined at least partially based on the plurality of miss-curves.

20. The system of claim 15, wherein the first type of memory comprises dynamic random access memory (DRAM), and the second type of memory comprises non-volatile memory (NVM).
